(19) United States
(12) Patent Application Publication
(10) Pub. No.: US 2008/0201252 A1
(43) Pub. Date: Aug. 21, 2008

(54) Internet-based auction and networking method

(76) Inventors: Robert L. Ingraselino, Coram, NY (US); Joseph V. Ingraselino, Sayville, NY (US)

Correspondence Address: Robert L. Ingraselino / Joseph V. Ingraselino, 592 Fulton Ave, Sayville, NY, 11782, US

(21) Appl. No.: 11/700,856

(22) Filed: Jan. 31, 2007

(51) Int. Cl. G06Q 30/00

(52) U.S. Cl. 705/37

(57) ABSTRACT

An internet-based auction and network method to create a network for all services needed and service providers. It allows service providers to create their own network page about their company, with pictures of past jobs, contact information, background of their company recommendations they have for other service providers as well as comments from past customers. One key element to the site is a real time auction where anyone who needs work done is able to create an auction in their category and have service providers bid using an underbidding with an offer connected method to allow for the lowest monetary price connected to the best offer example-bid-$2500-offer-finish in four days. The host of the auction has the option to end the auction at any time before its timed finish. The site will have a full directory of all service providers to allow for direct contact between service providers and customers needing a service performed. Another feature available to the service providers is a full database of suppliers, where the service providers will place supplies up for auction using the underbidding with offer connected method to

### FIELD OF THE INVENTION

The present invention relates to Internet-based auctions and networking methods and, more particularly a method and system that enables users to place a service needed up for bid where the service providers use an underbidding auction process with an offer connected to the bid, also allowing service providers to create their own networking page with pictures of past work, contact information, background of their company and recommendations they have for other service providers, also allowing suppliers for the service providers to network using the underbidding with an offer connected method to offer supplies via auction, also allowing users to have a directory link to contact the service providers directly over electronic networks, particularly the Internet.

### BACKGROUND OF THE INVENTION

Service providers and consumers needing services done are limited to the networking tools accessible to them, this invention provides an internet-based networking site to help service providers, people who need services done and suppliers to put a job or supply up for bid and bid on a (underbidding with offer connected) auction to secure the best monetary price available connected to the best offer available, the invention also helps service providers to network with suppliers and other service providers, also it solves the problem for consumers needing work done to allow them to see past jobs and history of work with service providers that they are entering into business with to secure a credible service provider.

There are other internet-based auction and networking methods. Typically of these is U.S. Pat. No. 7,110,976 issued to Scott Allen Heimermann/Stephen Danforth on Sep. 19, 2006. Another patent was issued to John Carlton-Foss on Nov. 11, 2003 as U.S. Pat. No. 6,647,373. Yet another U.S. Pat. No. 6,301,574 was issued to Brian Christopher Thomas/Jason Daniel Osborne. Another patent was issued to James Michael Odom/Scott D. Yellich as U.S. Pat. No. 6,058,379 on May 2, 2000. Another U.S. Pat. No. 5,890,138 was issued to Paul B. Godin/Jeffrey Lymburner on Mar. 30, 1999 and still yet another was issued on Jan. 17, 1989 to Eyal Shavit/Lester Teichner as U.S. Pat. No. 4,799,156.

While these patents may be suitable for the purposes they were designed, they would not be suitable for the purposes of the present invention, as hereinafter described.

It is therefore an object of the invention to provide an internet-based auction and network site for service providers, suppliers, and people who need services performed.

It is therefore an object of the invention to provide a main page with a list of all service categories available.

It is therefore another object of the invention to provide a full directory of all service providers for direct contact.

It is another object of the invention to provide a service provider network page which all the service providers can customize, with pictures of past jobs, contact information, background of their company, recommendations of other service providers

It is another object of the invention to provide customer comment page for all past customers comments.

It is another object of the invention to provide a real time auction where anyone who needs work done is able to create an auction in their needed category and have service providers bid.

It is another object of the invention to provide an auction bidding method where the bid offers decrease underbidding each other with an offer connected ex-bid-$2500, offer-finish in four days.

It is another object of the invention to provide a suppliers link for service providers to network with suppliers for supplies needed on their jobs.

It is another object of the invention to provide a real time auction where any service provider who needs supplies is able to create an auction in their category and have suppliers bid.

It is another object of the invention to provide an auction bidding method for the suppliers auction where the bid offers decrease, underbidding each other with an offer connected.

It is another object of the invention to provide a page where tools for the service providers will be sold and traded on display.

### SUMMARY OF THE INVENTION

In accordance with the present invention, there is provided an internet-based auction and network method to create a network for all services needed and service providers. It allows service providers to create their own network page about their company, with pictures of past jobs, contact information, background of their company recommendations they have for other service providers as well as comments from past customers. One key element to the site is a real time auction where anyone who needs work done is able to create an auction in their category and have service providers bid using an underbidding with an offer connected method to allow for the lowest monetary price connected to the best offer example-bid-$2500-offer-finish in four days. The host of the auction has the option to end the auction at any time before its timed finish. The site will have a full directory of all service providers to allow for direct contact between service providers and customers needing a service performed. Another feature available to the service providers is a full database of suppliers, where the service providers will place supplies up for auction using the underbidding with offer connected method to provide suppliers the right to underbid for supplies. Yet another feature is a section where tools for the service providers will be sold and traded on display.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a detail view of an internet-based network and auction method for service providers, services needed, and suppliers to auction services and supplies using a unique underbidding method with offer connected. Also, having personal network themselves with pictures of past jobs, contact information, history and recommendations of others in the community. Also, a page to buy and sell tools. Also, a page to leave comments of how the transactions went.

For purposes of clarity and brevity, like elements and components will bear the same designations and numbering throughout the Figures.

### DESCRIPTION OF THE PREFERRED EMBODIMENT

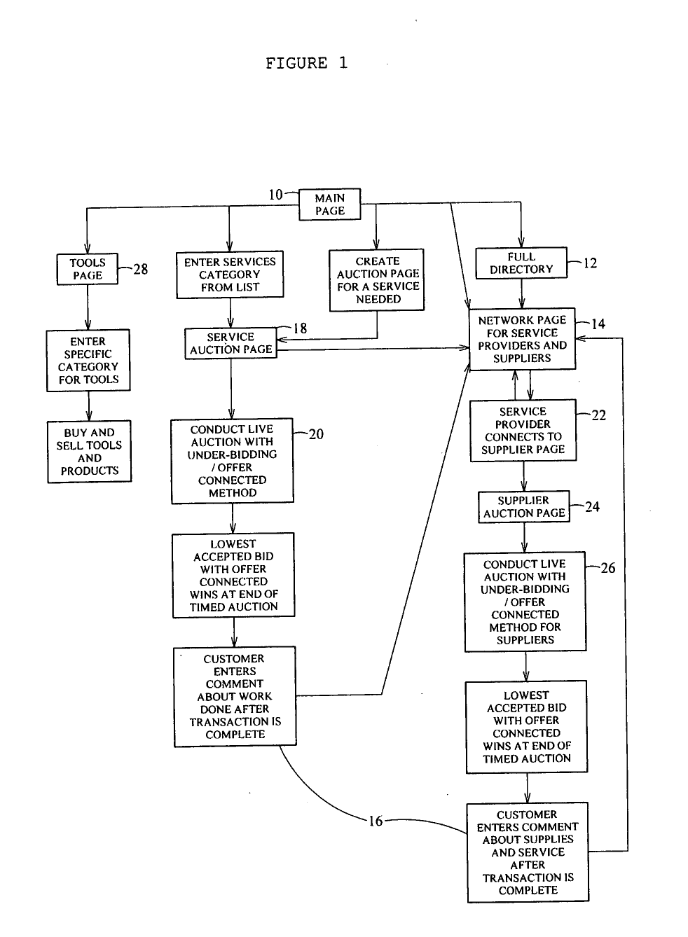

FIG. 1 is a is the complete layout of the internet-based networking and auction method. It shows the main page 10 having all of the service category links to enter the service auction page 18 which will conduct a real time auction bidding method 20 for services needed using the underbidding with offer connected method to bid on the services. The lowest bid being the winner at the end of the timed auction. Also shown is the full directory 12 link page for direct contact to all of the service providers. Also displayed is the network page 14 where service providers and suppliers can create their own personalized page with pictures of past jobs, history of their company, recommendations for other service providers, and contact information. Also shown is the supplier link 22 page for all of the service providers to network with suppliers in their category, where they can create a supply auction page 24 where supplies needed for jobs will be bid on using the bidding method 226 underbidding each other with an offer connected. After each auction has ended and the transaction is complete, both parties will be able to leave comments about the other party on the comment page 16. Last you will see the tools page 28 link where anyone who wants to buy or sell tools will be able to do so on this page.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. An internet-based auction and networking method for conducting auctions and networking for service providers, services that are required, and suppliers, comprising:
means for a main page with a list of all of the service categories available;
means for a full directory of all service providers for direct contact;
means for a service provider network page which all service providers can customize with pictures of past jobs, contact information, background of their company, and recommendations of other service providers;
means for a customer comment page for all past customers comments;
means for a real time auction page where users who need services performed are able to create an auction in their category and have service providers bid;
means for an auction bidding method where the bid offers decrease, underbidding each other with an offer connected, ex.-bid-$2500-offer-finish in four days;
means for a suppliers link for service providers to network with suppliers for supplies needed on their jobs;
means for a real time auction where any service provider who needs supplies is able to create an auction page in their category and have suppliers bid;
means for an auction bidding method where the bid offers decrease, underbidding each other with an offer connected, ex.-bid-$2500-offer-finish in four days; and
means for a page where tools for the service providers are sold and traded on display.

2. The internet-based auction and networking method in accordance with claim 1, wherein said means for a main page with a list of all of the service categories available comprises a main page.

3. The internet-based auction and networking method in accordance with claim 1, wherein said means for a full directory of all service providers for direct contact comprises a directory.

4. The internet-based auction and networking method in accordance with claim 1, wherein said means for a service provider network page which all service providers can customize with pictures of past jobs, contact information, background of their company, and recommendations of other service providers comprises a network page.

5. The internet-based auction and networking method in accordance with claim 1, wherein said means for a customer comment page for all past customers comments comprises a comment page.

6. The internet-based auction and networking method in accordance with claim 1, wherein said means for a real time auction page where users who need services performed are able to create an auction in their category and have service providers bid comprises a service auction page.

7. The internet-based auction and networking method in accordance with claim 1, wherein said means for an auction bidding method where the bid offers decrease, underbidding each other with an offer connected, ex.-bid-$2500-offer-finish in four days comprises a bidding method.

8. The internet-based auction and networking method in accordance with claim 1, wherein said means for a suppliers link for service providers to network with suppliers for supplies needed on their jobs comprises a supplier link.

9. The internet-based auction and networking method in accordance with claim 1, wherein said means for a real time auction where any service provider who needs supplies is able to create an auction page in their category and have suppliers bid comprises a supply auction page.

10. The internet-based auction and networking method in accordance with claim 1, wherein said means for an auction bidding method where the bid offers decrease, underbidding each other with an offer connected, ex.-bid-$2500-offer-finish in four days comprises a bidding method 2.

11. The internet-based auction and networking method in accordance with claim 1, wherein said means for a page where tools for the service providers are sold and traded on display comprises a tools page.

12. An internet-based auction and networking method for conducting auctions and networking for service providers, services that are required, and suppliers, comprising:
a main page, for a main page with a list of all of the service categories available;
a directory, for a full directory of all service providers for direct contact;
a network page, for a service provider network page which all service providers can customize with pictures of past jobs, contact information, background of their company, and recommendations of other service providers;
a comment page, for a customer comment page for all past customers comments;
a service auction page, for a real time auction page where users who need services performed are able to create an auction in their category and have service providers bid;
a bidding method, for an auction bidding method where the bid offers decrease, underbidding each other with an offer connected, ex.-bid-$2500-offer-finish in four days;
a supplier link, for a suppliers link for service providers to network with suppliers for supplies needed on their jobs;
a supply auction page, for a real time auction where any service provider who needs supplies is able to create an auction page in their category and have suppliers bid;
a bidding method 2, for an auction bidding method where the bid offers decrease, underbidding each other with an offer connected, ex.-bid-$2500-offer-finish in four days; and
a tools page, for a page where tools for the service providers are sold and traded on display.

13. An internet-based auction and networking method for conducting auctions and networking for service providers, services that are required, and suppliers, comprising:
a main page, for a main page with a list of all of the service categories available;
a directory, for a full directory of all service providers for direct contact;
a network page, for a service provider network page which all service providers can customize with pictures of past jobs, contact information, background of their company, and recommendations of other service providers;
a comment page, for a customer comment page for all past customers comments;
a service auction page, for a real time auction page where users who need services performed are able to create an auction in their category and have service providers bid;
a bidding method, for an auction bidding method where the bid offers decrease, underbidding each other with an offer connected, ex.-bid-$2500-offer-finish in four days;
a supplier link, for a suppliers link for service providers to network with suppliers for supplies needed on their jobs;
a supply auction page, for a real time auction where any service provider who needs supplies is able to create an auction page in their category and have suppliers bid;
a bidding method 2, for an auction bidding method where the bid offers decrease, underbidding each other with an offer connected, ex.-bid-$2500-offer-finish in four days; and
a tools page, for a page where tools for the service providers are sold and traded on display.
